(19) United States
(12) Patent Application Publication
(10) Pub. No.: US 2009/0296760 A1
(43) Pub. Date: Dec. 3, 2009

(54) Optical Pumping Apparatus and Method to Reduce AC Stark Shift in Atomic Frequency Standards

(76) Inventor: Miao Zhu, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/127,800

(22) Filed: May 27, 2008

(51) Int. Cl. H01S 3/13

(52) U.S. Cl. 372/32

(57) ABSTRACT

An optical pumping atomic frequency apparatus for producing an oscillation signal with a stable frequency comprises a cell containing atomic particles of a quantum absorber material whose atomic particles have two clock transition states and first and second excited states. A static bias magnetic field is provided at the cell. A first electromagnetic (EM) field is provided to the cell, to excite transitions between at least one of the clock transition states and at least one of the first and second excited states due to absorption of the first EM field by the atomic particles in the at least one of the clock transition states, in order to alter the relative population of the atomic particles. A second EM field is applied to the cell, to induce transitions between the two clock transition states, so that the absorption of the first EM field by the atomic particles increases. Absorption of the first EM field is detected. The frequency spectrum of the first and second EM fields are controlled; so that the frequency of the output oscillating signal is related to the clock transition frequency. The interactions between the atomic particles and the first EM field cause a light shift as a function of the intensity and the frequency of the first EM field, the light shift having a characteristic curve. The light shift has an absolute value which is related to the frequency and polarization of the first EM field, and the frequency and polarization are chosen to reduce the absolute value of the light shift. The light shift curve has a slope at the frequency which corresponds with an energy difference between the at least one of the clock states and the at least one of the first and second excited states, the slope thereat related to the chemical composition and partial pressure of the buffer gas in the cell. The composition and pressure of the buffer gas reduce the absolute value of the slope of the light shift curve of the clock transition frequency to approximately zero.

### BACKGROUND OF THE INVENTION

A local oscillator is used in many instruments, e.g., frequency synthesizers, frequency counters, etc., to provide a reference frequency or a reference time base, often referred to as a “clock.”. To make useful measurements in a test setup with multiple instruments, one often needs to synchronize some or all of the local oscillators in the instruments in the test setup to a “master” oscillator. Optimal frequency precision and stability are desirable for this master oscillator. Quartz crystal oscillator technology has been used for generating reference oscillations.

Another technology employs quantum absorbers, such as individual atomic particles, ions, low-molecular weight compounds, etc., which may be collectively referred to as “atomic particles.” In general the devices based on this technology are called atomic frequency standards. The output frequency of an atomic frequency standard is related to a frequency defined by energy difference of two energy levels (two energy states) in the atomic particles. In one group of the atomic frequency standards, the quantum absorbers are generally in the form of low-pressure vapors, confined by means such as a vessel or an electromagnetic potential well.

The atomic particles have discrete energy states (i.e., energy levels), such as a ground state and a sequence of successively higher-energy excited states. Each such energy state has a respective population of atomic particles. At a quiescent condition, such as a state of thermal equilibrium, there is a respective population of atomic particles for each of the energy states. As the atomic particles transition between energy states, the populations change. Energies of transition between the energy levels correspond with electromagnetic frequencies, according to the familiar photoelectric-effect equation E=hv= [symbol] ω. (In the latter part of this equation, [symbol] =h/2π is the reduced Planck constant.) Where two energy states are chosen as “clock transition” states, electromagnetic radiation of a frequency corresponding with the difference between the energy levels of the clock transition states may be the basis for a clock signal of that frequency.

The clock signal will have a strength related to a net transition rate of atomic particles from one of the clock transition states to the other clock transition states. Relative to background or ambient electromagnetic “noise,” the clock signal will have a signal-to-noise ratio, which preferably should be as large as possible. One way of improving the signal-to-noise ratio in the atomic frequency standards, called “optical pumping,” employs an electromagnetic field, the so-called “optical pumping field”, to change the populations of the atomic particles.

However, the accuracy and precision of such atomic frequency standards are limited by the fact that variations in the respective energy levels arise. One of these variations is due to a physical phenomenon, called the AC Stark shift, which limits the performance of such an optically pumped atomic frequency standard because the energy level variations result in less stable clock signal frequency. The AC Stark shift originates from the interaction between the optical pumping field and the quantum absorber.

### SUMMARY OF THE INVENTION

An optical pumping atomic frequency apparatus for producing an oscillation signal with a stable frequency comprises a cell containing atomic particles of a quantum absorber material whose atomic particles have two clock transition states and first and second excited states. A static bias magnetic field is provided at the cell. A first electromagnetic (EM) field is provided to the cell, to excite transitions between at least one of the clock transition states and at least one of the first and second excited states due to absorption of the first EM field by the atomic particles in the at least one of the clock transition states, in order to alter the relative population of the atomic particles. A second EM field is applied to the cell, to induce transitions between the two clock transition states, so that the absorption of the first EM field by the atomic particles increases. Absorption of the first EM field is detected. The frequency spectrum of the first and second EM fields are controlled; a so that the frequency of the output oscillating signal is related to the clock transition frequency. The interactions between the atomic particles and the first EM field cause a light shift as a function of the intensity and the frequency of the first EM field, the light shift having a characteristic curve. The light shift has an absolute value which is related to the frequency and polarization of the first EM field, and the frequency and polarization are chosen to reduce the absolute value of the light shift. The light shift curve has a slope at the frequency which corresponds with an energy difference between the at least one of the clock states and the at least one of the first and second excited states, the slope thereat related to the chemical composition and partial pressure of the buffer gas in the cell. The composition and pressure of the buffer gas reduce the absolute value of the slope of the light shift curve of the clock transition frequency to approximately zero.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a block diagram of a system incorporating an embodiment of the invention.

FIGS. 2, and 3 are simplified partial energy state diagrams showing respective ground and excited energy states, transitions between the energy states, and hyperfine variations of the energy levels associated with given ones of the energy states.

FIG. 4 is a graph showing AC Stark shift of an energy state |2> as a function of laser frequency detuning, corresponding with the energy state diagram of FIG. 2.

FIGS. 5, 6, and 7 are graphs showing AC Stark shift of an energy state |2> as a function of laser frequency detuning, corresponding with the energy state diagram of FIG. 3, for three different line widths of the excited state.

FIG. 8 is a graph showing further aspects of the laser frequency detuning, corresponding with the energy states of FIG. 3.

FIG. 9 is a simplified energy state diagram showing further aspects of energy levels in the particular case of a quantum absorber material of an isotope of Rubidium.

FIG. 10 is a flowchart incorporating an embodiment of the invention.

### DETAILED DESCRIPTION

### Atomic Energy States

Inside an atomic particle there will be electrostatic interaction between the electrons and the nucleus or nuclei. This interaction results in the discrete energy states in an atomic particle. The state with the lowest energy is called the ground state, while all the other states with higher energies are called excited states.

Energy states and/or substates may be expressed quantitatively in terms of their energy values (such as in terms of electron volts of energy), or in terms of an ordinally-numbered sequence, related to their successively higher-energy states. In the latter case, we will denote a ground state as having substates |1> and |2>, an excited state as having a substate |3> and perhaps also a substate |4>, etc. Algebraic expressions, as well as numerals, may be used in this notation.

The interactions inside an atomic particle can split each of these energy states into fine states and further into hyperfine states, subject to the restrictions of quantum physics. (The hyperfine splitting is mainly due to the interaction of the nuclear magnetic dipole moment with the magnetic field produced at the nucleus by the electrons; but in some cases the finite extent of the nuclear electric charge distribution, the electric quadrupole moment, is also significant.) Each hyperfine state is denoted by a quantum number, F, describing its total angular momentum in addition to the other quantum numbers describing the fine state to which it belongs.

Furthermore, each hyperfine state comprises several sub-states, which are called Zeeman states. These sub-states have the same energy in the absence of external electromagnetic fields. A small bias static magnetic field lifts the energy degeneracy of the sub-states and defines the quantization axis. Each sub-state is denoted by a quantum number, m_{F}, describing the projection of the total angular momentum along the quantization axis. Traditionally, F′ and m_{F}′, instead of F and m_{F}, are used to denote the sub-state if it belongs to an excited state.

We may say, broadly, that the term “substate” (or “sub-state”) refers, generically, to any of the successively finer levels of states achieved by splitting a state at the next higher level. For instance, hyperfine states are substates of the ground state and/or the excited states mentioned above, and Zeeman states are substates of those hyperfine states. However, for some of the specific examples given below, “substates” will refer specifically to the latter, i.e., to Zeeman states.

In descriptions of substates, we will use a notation similar to that given above, but employing an ordered pair of numerals or algebraic expressions to refer to the state and the substate. For instance, we might use the notation |1, 2> to refer to a second substate of a first state.

In the discussion of atomic clocks and frequency standards which follows, clock transitions between states will be described. The clock transition usually is a transition between two particular states, which will be referred to as the clock transition states. Often they are two Zeeman states; one of them belongs to one of the hyperfine state in the atom's ground state while the other belongs to a different hyperfine state in the atom's ground state. This will be the case for the specific examples discussed herein. The clock transition states are chosen so that the clock transition frequency is less sensitive to the external conditions, e.g., the external magnetic field.

### Atomic Frequency Standards (Atomic Clocks):

According to the principles of quantum mechanics, all isolated atomic particles of the same kind (same element and same isotope) have identical energy state structure. The frequency corresponding to the energy difference between two given states is the same for all the isolated atomic particles of the same kind, at rest. Therefore this frequency can be used as a stable frequency standard. This is the basis of an atomic frequency standard, which is also called an atomic clock. The two states, which define the stable frequency standard, are called clock transition states.

The clock transition states are chosen based on many physical characteristics of the atomic particles (and the available technologies to practically realize the atomic frequency standard). For example, it is desirable to choose the clock transition states such that the clock transition frequency is less sensitive to the external conditions, e.g., the external magnetic field. As a result, a common atomic frequency standard is based on the frequency between two hyperfine states in the ground state of an atom such as the rubidium (Rb) atom or the cesium (Cs) atom. The corresponding frequency, the clock frequency, is on the order of ten GHz, which falls within the microwave portion of the electromagnetic spectrum. These atomic frequency standards are sometimes called microwave atomic frequency standards, in order to distinguish them from the optical atomic frequency standards. (Optical frequencies are greater than microwave frequencies, by a factor on the order of about 100,000.)

When the chosen atomic particles are exposed to an electromagnetic field with a frequency in the vicinity of the clock frequency, the atomic particles can make transitions from one clock state to the other clock state. (This electromagnetic field will generally be referred to as a “second EM field.”) Observing this transition is a method to interrogate the atomic particles in the process of realizing the atomic frequency standards. That is, if we observe the transition between clock states of a frequency corresponding with the difference in energy levels, that observed frequency forms the basis for the clock.

Precision may be enhanced by reducing the perturbations to the clock transition states in the atomic particles. One way to do so is to confine the atomic particles in a vessel such as a vapor cell, in order to realize a more compact device.

Interaction between the atomic particles and the cell walls may deteriorate the performance of the atomic frequency standard. A buffer gas is introduced into the cell, to reduce this interaction. The components of the buffer gas are chosen to reduce the other undesirable effects on the clock transition states. The buffer gas may, for instance, include multiple gaseous components such as a mixture of nitrogen and argon, or a mixture of methane and argon.

In the last several years, the development of miniature atomic frequency standards has received funding from DARPA's chip scale atomic clock (CSAC) program. Relative to a quartz crystal oscillator, an atomic frequency standard in an instrument achieves: (1) better short term stability; (2) better frequency re-traceability, and (3) longer averaging (holding) time.

### Populations at Thermal Equilibrium; Optical Pumping:

In a typical microwave atomic frequency standard, the thermal energy corresponding to the clock transition frequency is less than one Kelvin. Therefore in the thermal equilibrium near the room temperature (˜300 K) the atomic particles have almost the same population in the two clock states. When an electromagnetic field with a frequency near the clock frequency is applied to the atomic particles, the number of the atomic particles that make transition from one clock state to the other is almost the same as the number of the atomic particles making the reverse transition. Hence the observed signal for the transition between the two clock states is very small, and may be difficult to discern out of background noise.

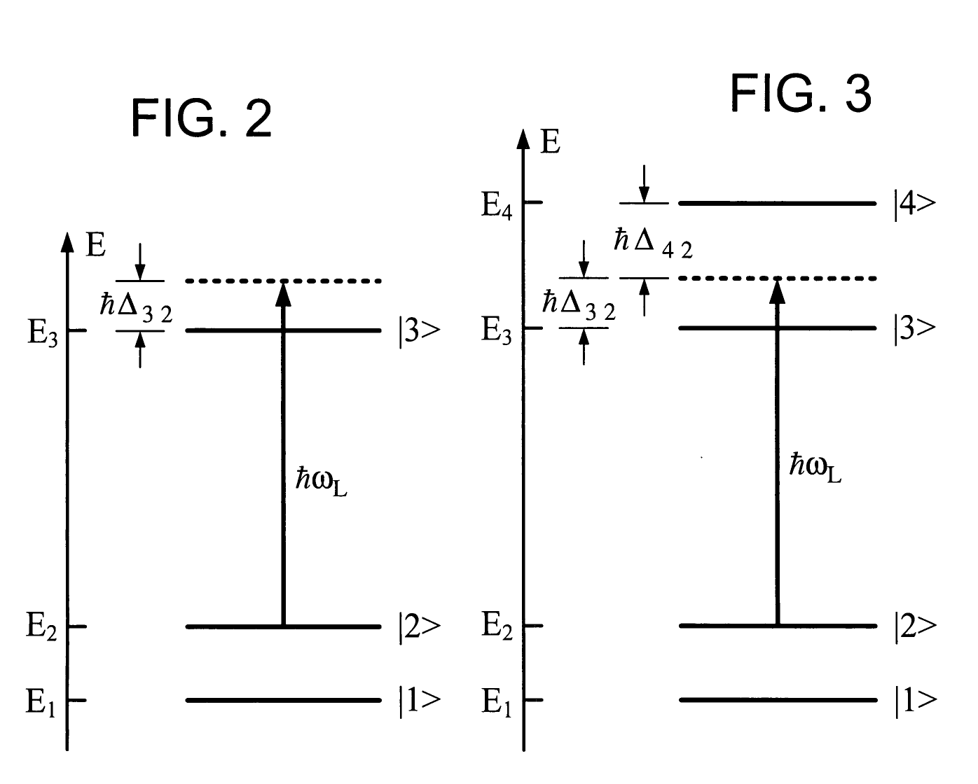

The clock transition signal in a microwave atomic frequency standard may be enhanced using a technique called “optical pumping.” This method uses an additional electromagnetic field with optical frequency (infrared, visible, or ultraviolet), to cause atomic particles in one of the clock states to make transitions to a selected excited state. (This field will be referred to herein as a “first EM field”, or in a specific example, as an “optical pumping field.”) For instance, in the energy state diagram of FIG. 2, a transition is shown between one of the clock states |2> to an excited state |3>. The atomic particles in the other clock state (state |1>) are not affected. The atomic particles in the selected excited state can decay to either of the clock states |1> or |2>. Since these atomic particles were all in the clock state |2>, but some of them decay into the clock state |1> instead of returning to the clock state |2>, the net effect of this optical pumping is that the atomic population in state |2> decreases, and the population in the state |1> increases. So this optical pumping is also called Population Altering Pumping.

When the microwave field frequency is close to the clock transition frequency, more atomic particles make transitions from state |1> to state |2> than the other way around, and the absorption of the optical field increases. Thus the application of the optical pumping field also provides a method to observe the clock transition signal.

### AC Stark Shift:

The Stark shift (or the DC Stark shift) is the energy change of the atomic energy states due to the interaction between the atomic particles and the external electrostatic field. This energy shift is very small. In some simple cases, e.g., in the hydrogen atom, the DC Stark shift can be calculated exactly.

Similarly, the interaction between the atomic particle and the external optical field also causes the energy shift of the atomic energy states. This shift is called AC Stark shift. Sometimes this is also called light shift. The AC Stark shift is enhanced when the optical frequency is close to an atomic transition frequency. Typically the AC Stark shift is calculated using perturbation method.

There are two consequences of AC Stark shift in an atomic frequency standard: (1) the observed clock frequency changes when the optical field intensity changes if the optical frequency is not exactly in resonance with the atomic transition; and (2) the observed clock frequency changes when the optical frequency changes. Thus the observed clock frequency fluctuates when the intensity and/or the frequency of the optical field fluctuate. This is one of the major limitations on the performance of the optical pumping based atomic frequency standards.

The most effective way to eliminate the AC Stark shift would be to eliminate the optical pumping field completely, at the time when the atomic particles are interrogated by the microwave field. This approach would require a light intensity modulator. If a laser were used as the source of the optical pumping field, an additional atomic absorption cell would be required for stabilizing the laser frequency. Therefore this approach is cumbersome, and it is difficult and expensive to make a compact device based on this approach.

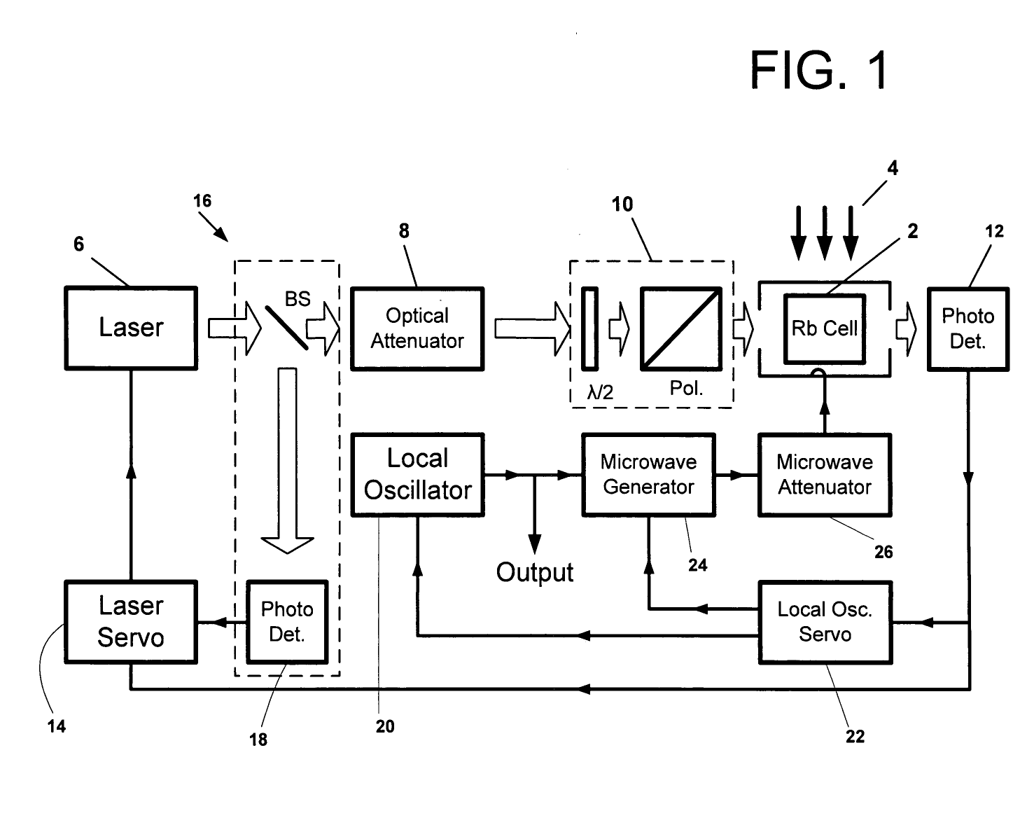

### FIG. 1—System Block Diagram

FIG. 1 is a block diagram of a system embodying the invention. A quantum absorber material is confined within a cell 2. The cell 2 may include a vessel, an electromagnetic confinement field, etc.

The quantum absorber material may, for instance, include a low-pressure vapor of atomic particles such as Li, Na, K, Rb, or Cs. Alternatively, the quantum absorber material may include ions such as Be⁺, Mg⁺, Ca⁺, Sr⁺, Yb⁺, Ba⁺, Zn⁺, Cd⁺, or Hg⁺. In the example of FIG. 1, the cell 2 is labeled as containing a vapor of Rubidium (Rb) atomic particles. A buffer material, such as a buffer gas, may also be included within the cell 2.

The quantum absorber material within the cell 2 has a set of energy levels, including a ground level and a sequence of successively higher-energy excited levels, that are characteristic of the material. In a state of thermal equilibrium, atomic particles of the quantum absorber material will be in respective first populations, for each of the respective energy states.

Further aspects of the cell 2 and its quantum absorber material, and its energy levels, will be discussed in detail below, in connection with FIGS. 2-6.

Referring again to FIG. 1, a static bias magnetic field 4, such as a DC field, is applied to the cell 2 by an appropriate static magnetic field generator. The static bias magnetic field 4 is oriented, relative to the cell 2, in a predetermined direction.

A first EM field, called an “optical pumping field,” such as a laser beam, is applied to the cell 2, to excite transitions between a selected one of the two clock transition substates of the ground state, and the excited state. Applying the first electromagnetic field changes the respective populations of atomic particles of the quantum absorber within the ground state and the excited state to respective second values. For a quantum absorber material having a ground state and a higher-energy excited state, it will be understood that the second value of the excited state will be greater than the first value of the excited state, and the second value of the ground state will be less than the first value at the ground state. Furthermore, applying the first electromagnetic field changes the relative populations of the atomic particles among the substates of the hyperfine states that belong to the ground state.

In FIG. 1, the apparatus for producing the first EM field is shown as a laser apparatus, including a laser light source 6. The laser light may be attenuated, by an optical attenuator 8, to adjust the intensity of the laser beam to be applied to the cell 2. The laser beam may also have its polarization defined, or adjusted, by a polarization apparatus 10, such as a linear polarizer.

The first EM field is affected by the energy it imparts to excite the atomic particles of the quantum absorber material within the cell 2 as described above. Thus, the first EM field emerging from the cell 2 may be detected and examined to determine how it was affected. A photodetector 12 detects the first EM field emerging from the cell 2, and provides it as feedback to a laser servo 14, which operates the laser light source 6, for instance by controlling the laser frequency. An additional feedback/control apparatus 16 may be provided, which taps the laser light output from the laser light source 6 for instance using a beam splitter (BS) and a photodetector 18. This signal is used to adjust and/or servo the laser beam intensity.

The output of the photodetector 12 is additionally used to provide an output signal from the apparatus of FIG. 1. The output signal will be discussed further below. FIG. 1 includes a local oscillator 20, which is controlled by a local oscillator servo 22 based on the output of the photodetector 12. The output of the local oscillator 20 is provided as an output of the system.

A second EM field, such as a microwave field, is also applied to the cell 2, for the purpose of inducing the clock transition. As noted above, microwaves have a lower frequency, and therefore lower energy, than the first EM field which causes the optical pumping to the excited state. In an embodiment of the invention, the energy difference between the two clock transition substates of the ground state is less than the differences between the excited state and either of the clock transition substates.

The output signal of the photodetector 12 is provided to a local oscillator servo 22 for controlling a microwave generator 24. The microwave output of the microwave generator 24 is attenuated by a microwave attenuator 26. The attenuated microwaves optionally adjust and/or servo the microwave field intensity.

### FIGS. 2-7—Energy Level Diagrams and Energy Curves

FIGS. 2 and 3 are energy level diagrams show examples of energy states for the quantum absorber material, and transitions between them. The vertical axes are energy. The two clock transition substates of the ground state are marked, by energy value, as E₁ and E₂. Two substates of an excited state are marked as E₃ and E₄.

The dotted line represents the photon energy of the applied first EM field (for instance, an optical laser field) with respect to the energy of the clock transition state |2>. The term “detuning” is defined as the difference between the dotted line and the solid line of a chosen state.

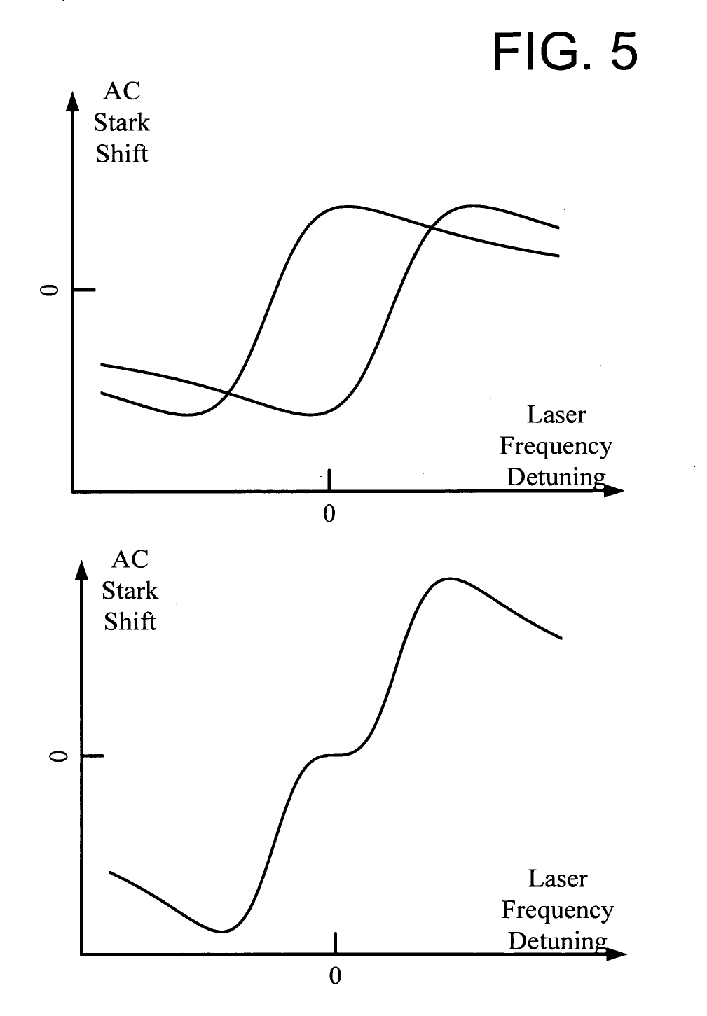

FIGS. 5, 6, and 7 are three pairs of graphs representing curves for the AC Stark shift for the state |2> of the energy diagram of FIG. 3, as a function of laser detuning, for the energy state diagram of FIG. 3. Here, the laser detuning is given by the expression ω_{L}−[(E₃+E₄)/2−E₂]/

[symbol]

For each pair of graphs, there is an upper graph showing two curves, and a lower graph, on the same scale, representing the sum of those two curves.

The two curves of the upper graphs respectively correspond to the transition between the energy states |2> and |3>, and the transition between the energy states |2> and |4>. The curves are similar in shape, but the latter curve is displaced to the right, due to the greater energy difference between the states |2> and |4> relative to that between the states |2> and |3>.

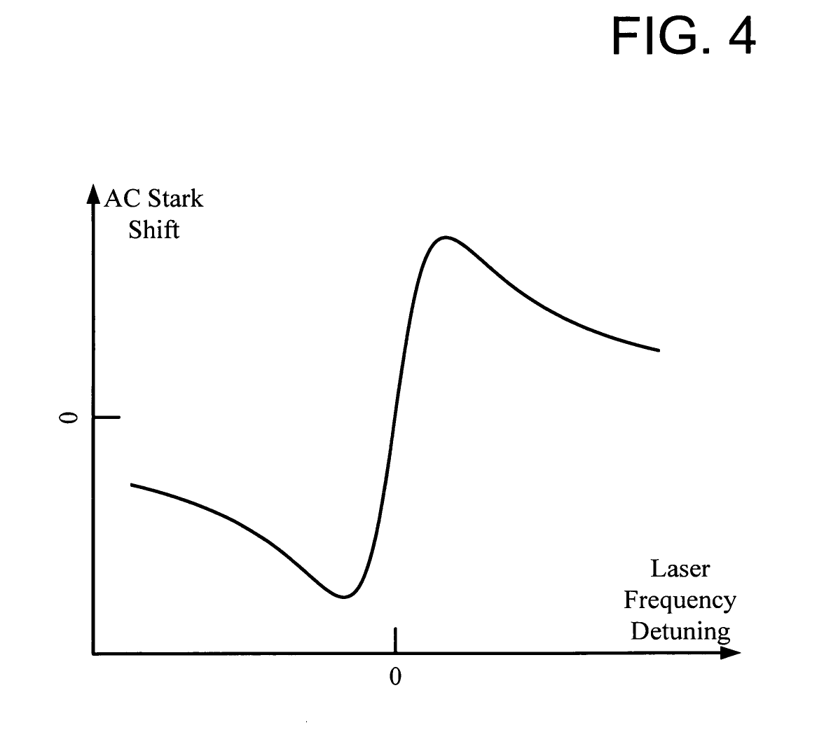

Note, incidentally, that in a corresponding graph for FIG. 2, which does not have a state |4>, there would be only one such curve, as shown in FIG. 4, for the transition between the states |2> and |3>. In this case, the laser frequency detuning is given by the expression ω_{L}−(E₃−E₂)/

[symbol]

A word on notation used in these energy level diagrams: energy levels are represented by quantum energy state expressions, such as |1>. In the discussion that follows, the energy value of such a quantum energy state is expressed, for instance, as E₁. Other energy values will be designated with subscripts which will be understood from the context of the discussion, even if not always illustrated in the energy level diagrams of FIGS. 2 and 3, or in the graphs of FIGS. 4-7.

The ground state and the excited states can split into more than one hyperfine state (HFS), due to interactions between the electron(s) and the nucleus in the atom. (A quantum number, I, is used to show the nuclear spin.) In FIGS. 2 and 3, the states |1> and |2> are hyperfine states in the ground state. In FIG. 2, the state |3> is one hyperfine state (or substate) within an excited state. In FIG. 3, the states |3> and |4> are two hyperfine states within an excited state.

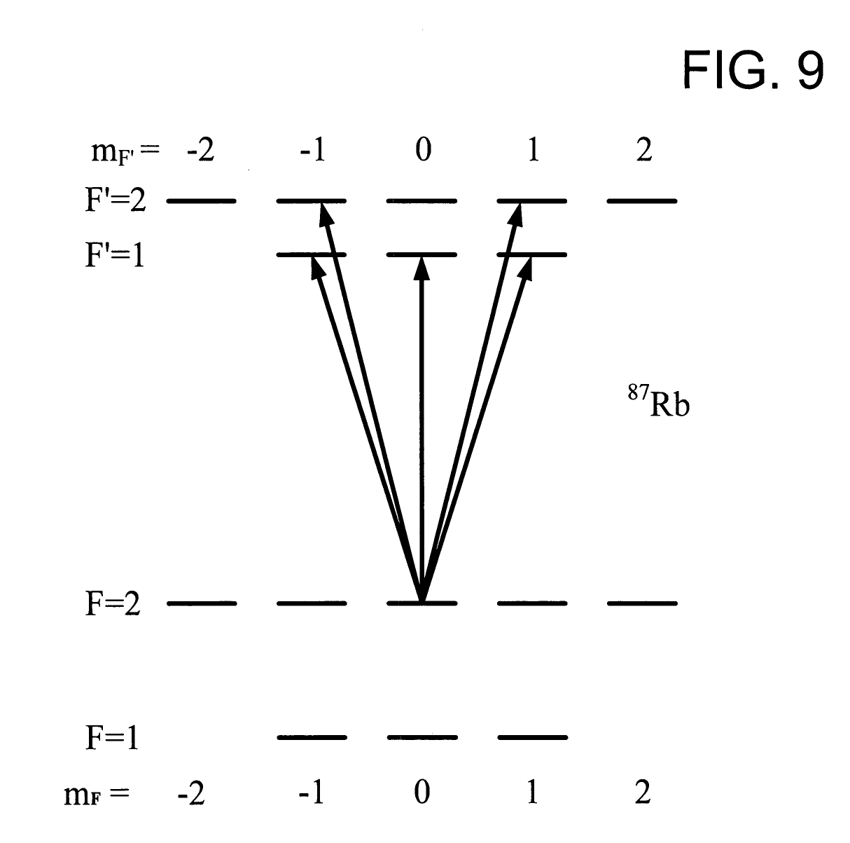

The splitting of states into hyperfine states and Zeeman states may also be observed in the energy diagram of FIG. 9. Each hyperfine state is labeled in FIG. 9 by a quantum number F (for the ground state) or F′ (for the excited state). Each such energy state can have more than one substate, the Zeeman state. Each Zeeman state is labeled by a quantum number m_{F} (for the ground state) or m_{F′} (for the excited state).

### FIGS. 2 and 4—One Excited State |3> for Optical Pumping

In a three-level system as shown in FIG. 2, the reference frequency of an atomic frequency standard is based on the energies of the clock transition states |2> and |1>, i.e., ω_{ref}=(E₂−E₁)/ [symbol] , where [symbol] is the reduced Planck constant. The observed frequency, ω_{obs}=(E₂+δE₂−E₁−δE₁/ [symbol] , includes all the possible energy shifts of the states, δE₂ and δE₁. These energy shifts and their dependence on the environmental perturbation parameters deteriorate the performance of the frequency standard.

A signal-to-noise ratio may be related to the population difference between |2> and |1>. This can be increased by using a laser (or other type of optical source) to connect one of the states, say |2>, to an excited state, |3>. The laser frequency, ω_{L}, is usually tuned close to the resonance frequency (E₃−E₂)/ [symbol] to maximize the optical pumping efficiency.

In addition to generating a large population difference between the clock transition states |2> and |1>, the interaction of the optical field and the atomic states shifts the energies of |2> and |1> slightly. This is so-called AC Stark shift or light shift.

For the energy diagram of FIG. 2, the AC Stark shift for the state |μ> (where μ is a variable of value either 1 or 2, depending on which of the two clock transition states |1> and |2> is involved) is given by

$$Δ {E}_{μ ACStark} = \frac{ℏ {ω}_{R 3 μ}^{2}}{4} \frac{{Δ}_{3 μ}}{{Δ}_{3 μ}^{2} + {γ}_{3}^{2}} \qquad ( Eq . 1 )$$

where ω_{R3}μ is the Rabi frequency for the optical pumping transition. |μ>→|3>, Δ₃μ=ω_{L}−(E₃−E_{λ})/ [symbol] is the detuning, and γ₃ is the line width (HWHM) of the transition. This line width is determined by the lifetime of the excited state |3>, and the other de-phasing processes, e.g., the collision between the atomic particle and the buffer gas molecules. The square of the Rabi frequency is proportional to the optical pumping field intensity. Detuning has a negative value if the laser frequency is less than the atomic transition frequency, and a positive value if the laser frequency is greater than the atomic transition frequency.

FIG. 4 is a graph of AC Stark Shift of the state |2> as a function of laser frequency detuning, corresponding with the energy state diagram of FIG. 2, with reference to optical pumping transitions from the clock transition state |2> to the excited state |3>.

This change of the sign of the detuning may be observed in the curve of FIG. 4 as a function of the increase in laser frequency. The curve crosses the X-axis going from negative to positive. (We will also see this in the curves of FIGS. 5, 6, and 7, to be discussed below.).

Let us now discuss the AC Stark energy shift of the energy state |2>. This AC Stark shift will be denoted as ΔE_{2ACStark}. All the discussions apply, as well, to the AC Stark shift of the energy state |1>, denoted as ΔE_{1ACStark}.

The dispersion line shape of such an AC Stark shift has two consequences. First, there is a net energy shift, which is proportional to the intensity of the optical field, if Δ₃₂ is not zero. Second, the AC Stark shift is proportional to the detuning Δ₃₂ via the slope of the AC Stark shift in the vicinity of Δ₃₂=0.

To increase the precision of the atomic frequency standard in a laser-microwave-atom-system, the AC Stark shift is mitigated, so that the dependence of the observed reference frequency ω_{obs} on the laser intensity and/or the laser frequency is largely reduced. In the curve of FIG. 4 this would be shown as a decrease in the absolute value of the slope of the AC Stark shift curve near the positive-slope zero crossing point of the curve.

The laser-atom-system may provide a distinct feature near the center of the frequency range mentioned above. The laser frequency can then be stabilized to this feature, for instance by using a conventional method.

### FIG. 3—Two Excited States |3> and |4> for Two Optical Pumping Transitions

An embodiment of the present invention provides such a system for the atomic frequency standard application. In an embodiment, more than one excited state in the atomic particle are used to reduce the AC Stark shift for a particular laser frequency (a specific detuning value). The absolute value of the slope of the AC Stark shift near this particular laser frequency is reduced by choosing the line widths of the excited states. Furthermore the laser frequency is stabilized to this particular value, for instance using a conventional method.

In FIG. 3, an additional excited energy state |4> with E₄>E₃ is provided. The total AC stark shift of state |2> is given by the expression

$$Δ {E}_{2 ACStark} = \frac{ℏ {ω}_{R 32}^{2}}{4} \frac{{Δ}_{32}}{{Δ}_{32}^{2} + {γ}_{3}^{2}} + \frac{{ℏω}_{R 42}^{2}}{4} \frac{{Δ}_{42}}{{Δ}_{42}^{2} + {γ}_{4}^{2}} \qquad ( Eq . 2 )$$

This is illustrated in the graphs of FIGS. 5, 6, and 7. The two terms of Eq. 2 are represented by two similarly-shaped curves, that are displaced horizontally from each other on the X axis (laser frequency detuning). The curve on the left represents the first term, which pertains to the transition between |2> and |3>. The curve on the right represents the second term, which pertains to the higher-energy transition between |2> and |4>. By summing the two curves (i.e., the two terms of Eq. 2), we obtain the curve shown in the graph beneath the graph showing the curves separately.

For each of the curves beneath, it will be seen that at a normalized laser frequency detuning value of 0, the AC Stark shift has a value of 0. That is, if ω_{R32}=ω_{R42}, γ₃=γ₄, and Δ₃₂=−Δ₄₂=(E₄−E₃)/(2 [symbol] ), the total AC Stark shift in Eq. 2 is zero.

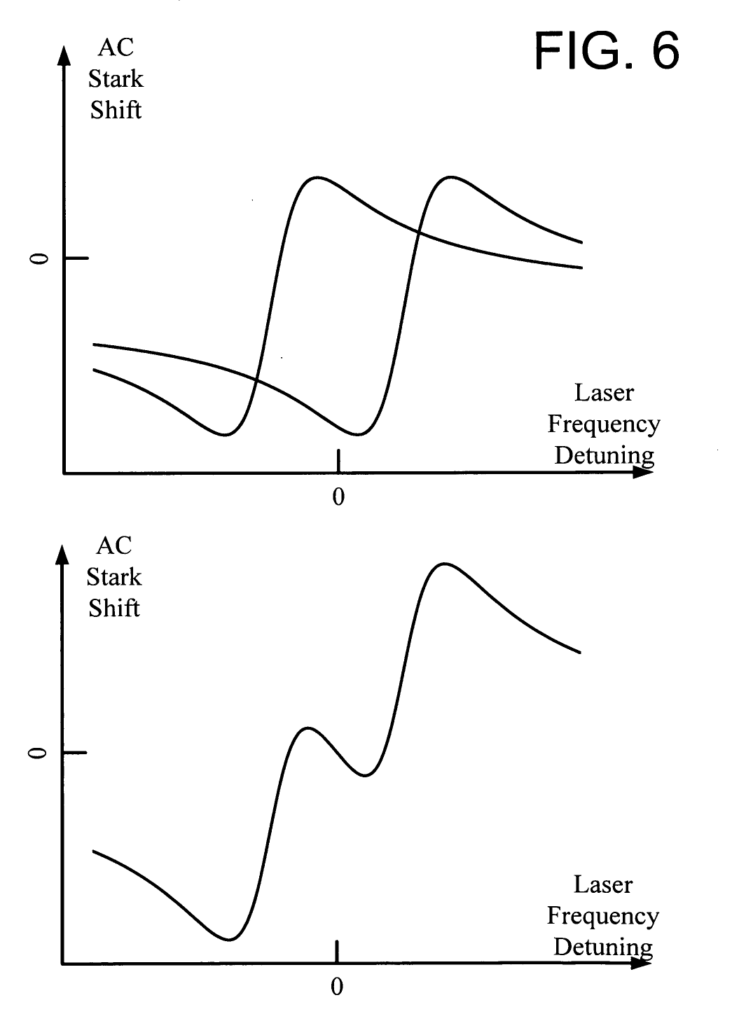

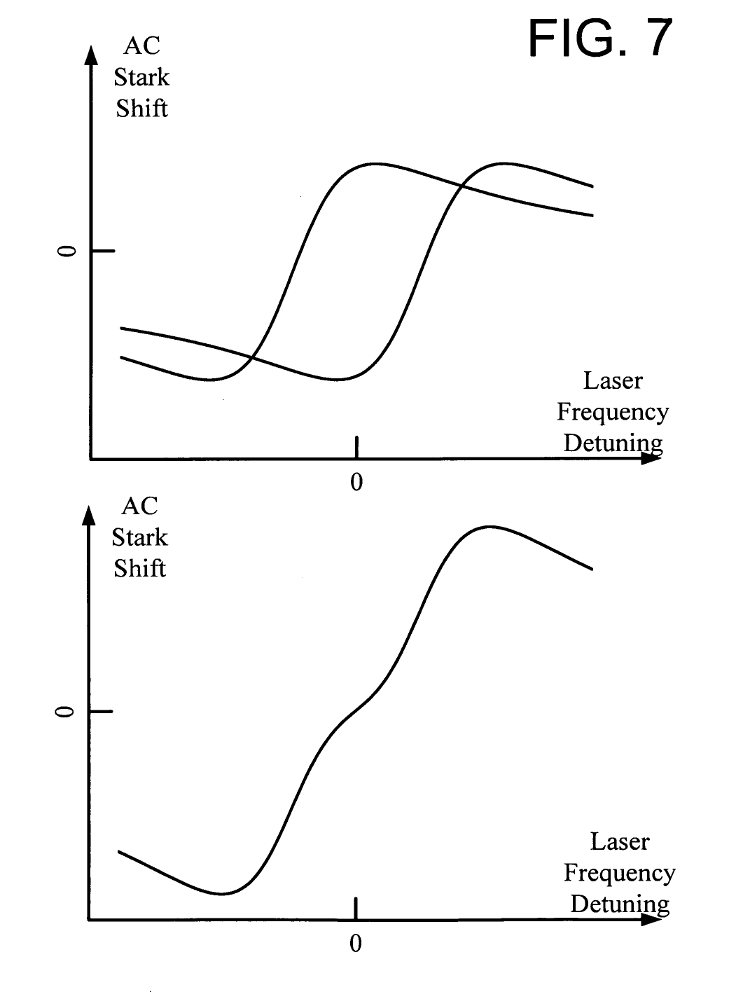

Note, further, that the three sum curves of FIGS. 5, 6, and 7 have regions near the zero point of laser detuning where their slopes are controllable. The slope of FIG. 5 is zero, the slope of FIG. 6 is negative, and the slope of FIG. 7 is positive. If we further choose the transition line widths properly, i.e., γ₃=γ₄=(E₄−E₃)/(2 [symbol] ), then the slope of the AC Stark shift is reduced to zero for Δ₃₂=−Δ₄₂=(E₄−E₃)/(2 [symbol] ); and the slope remains small in the vicinity of this detuning.

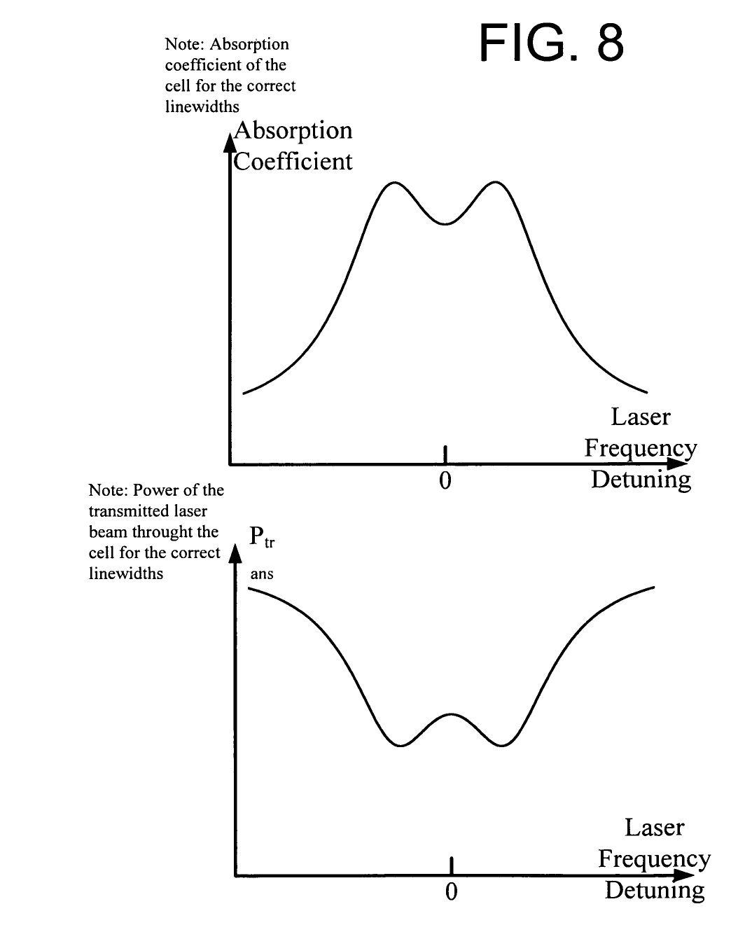

FIG. 8 shows a further aspect of the performance of a system with two excited optical pumping states as per FIG. 3. As a function of laser frequency detuning, the absorption of incident first EM radiation by the quantum absorber material within the cell 2 is shown. Under these conditions, the absorption of the light shows a local valley at a detuning value between the values where the two AC Stark shift curves cross zero in the positive direction as shown in FIGS. 5-7. Therefore a local peak is observed in the transmitted laser beam while a local valley is observed in the fluorescence. The absorption of the transmitted laser beam and/or fluorescence can be used to stabilize the laser frequency as well as to stabilize the local oscillator's frequency. The laser frequency could be readily locked to this local transmission peak (a distinct feature) using a frequency-dither-lock-in-detection method. Both transmitted laser beam and the fluorescence signal can be combined with proper ratio to improve the signal-to-noise ratio for laser frequency locking, for convenience. This design principle can be extended to the case where more than two excited states and/or more than one laser frequency are used.

### A SPECIFIC EXAMPLE

### A Rubidium Isotope

Let us now consider a specific example, in which the quantum absorber material is a vapor of atoms of the ⁸⁷Rb isotope of Rubidium. The energy levels of the D₁-line transition are shown in FIG. 9. The energy difference between the states |F=2, m_{F}=0> and |F=1, m_{F}=0> is used as a reference frequency for the atomic frequency standard.

Because of the selection rules of the electric dipole transition, |F=2, m_{F}=0> can be connected to |F′=1> states by both σ-polarization light and π-polarization light, but it can be connected to |F′=2> states only by σ-polarization light.

By choosing the proper intensity ratio of the σ-polarization light to the π-polarization light in the laser beam, we eliminate the AC Stark shift for the state |F=2, m_{F}=0> at the detuning −Δ_{F′=2→F=2}=Δ_{F′=1→F=2}. We further choose the buffer gas pressure to increase the homogeneous line width to eliminate the slope of the AC Stark shift at this detuning as mentioned above. The smaller AC Stark shift for the state |F=1, m_{F}=0> can be compensated by re-adjusting the intensity ratio of the σ-polarization light to the π-polarization light slightly.

### EMBODIMENT OF THE INVENTION AS A METHOD

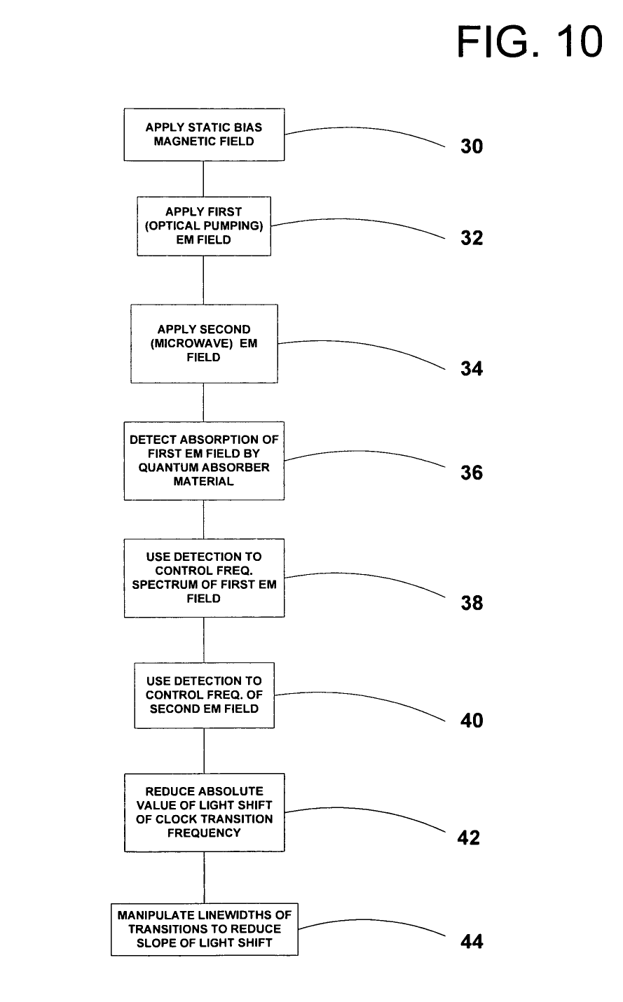

FIG. 10 is a flowchart showing the operation of an embodiment of the invention. A method is shown, for producing an output oscillating signal with a stable frequency, employing an apparatus including a quantum absorber material that includes a collection of atomic particles. The atomic particles have an energy state structure that includes a ground energy state including two clock transition states, and at least two excited states. The two clock transition states and the at least two excited states have respective populations of atomic particles. The respective populations, at a quiescent state such as thermal equilibrium, have values which will be subject to change as described herein. The method comprising the following activities:

A static bias magnetic field is applied (30) to the atomic particles.

A first EM field is applied (32) to the atomic particles. The first EM field may be an optical pumping EM field, having a frequency spectrum. The first EM field induces transitions between at least one of the clock transition states and at least one of the excited states. The transitions have characteristic linewidths. The transitions alter the respective populations of the atomic particles in the two clock states, so that the resultant population is different from what the populations at thermal equilibrium would be without the first EM field.

A second EM field is applied (34), to induce transitions between the two clock transition states. This alters the populations at the two clock transition states, for instance to provide more atomic particles to be optically pumped from one of the clock transition states to the excited state. Thus, the absorption of the first EM field by the atomic particles increases. The frequency of the second EM field is related to the frequency of the output oscillating signal.

Absorption of the first EM field by the atomic particles is detected (36). Fluorescence may also be detected.

The detection (36) of the absorption of the first EM field is used (38) to control the frequency spectrum of the first EM field.

The detection (36) of the absorption of the first EM field is also used (40) to control the frequency of the second EM field, so that the frequency of the output oscillating signal is related to the clock transition frequency.

The energy state structure in the atomic particle's excited states is used (42) to reduce, or ideally to eliminate, the absolute value of the light shift of the clock transition frequency. (42 is accomplished by choosing and controlling the frequency spectrum and the polarization of the first EM field.)

The linewidths of the transitions from the clock transition states to the excited states are manipulated (44) to reduce the absolute value of the slope of the light shift of the clock transition frequency.

In summary, an embodiment of the invention provides a laser-microwave-atomic particle-system whose output frequency has little dependence on the laser intensity and laser frequency. Furthermore, the dependence of the output frequency on the microwave power is also greatly reduced. Experiments have shown that the performance of an atomic frequency standard based on such a system is improved.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. An optical pumping atomic frequency apparatus for producing an oscillation signal with a stable frequency, the apparatus comprising:
a cell for confining a mixture of a quantum absorber material and a buffer gas, the quantum absorber material including atomic particles having two clock transition states in the ground state and first and second excited states, the quantum absorber material having respective populations of atomic particles corresponding with respective ones of the clock transition and excited states;
a static bias magnetic field source, disposed to provide a static bias magnetic field oriented in a predetermined direction at the cell;
a first electromagnetic (EM) field generator for applying a first EM field to the cell, to excite transitions between at least one of the clock transition states and at least one of the first and second excited states due to absorption of the first EM field by the atomic particles in the at least one of the clock transition states, in order to alter the relative population of the atomic particles, the first EM field having a frequency range including a frequency which corresponds with an energy difference between the at least one of the clock transition states and the at least one of the first and second excited states;
a second EM field generator for applying a second EM field to the cell, to induce transitions between the two clock transition states, so that the absorption of the first electromagnetic field by the atomic particles increases, the frequency of the second EM field being related to the frequency of the output oscillating signal produced by the apparatus, the second EM field having a non-zero component along the direction of the bias magnetic field to excite the clock transition in the atomic particles;
a detector for detecting the absorption of the first EM field, the detection being used to control the frequency spectrum of the first EM field;
a frequency controller for using the detection of the absorption of the first electromagnetic field to control the frequency of the second EM field, so that the frequency of the output oscillating signal is related to the clock transition frequency;
wherein the transitions between energy states of the atomic particles cause a light shift as a function of the frequency of the first EM field, the light shift having a characteristic curve which includes a curve value at the frequency which corresponds with an energy difference between the at least one of the clock states and the at least one of the first and second excited states,
wherein the light shift has an absolute value which is related to the frequency and polarization of the first electromagnetic field, and the frequency and polarization are chosen to reduce or minimize the absolute value of the light shift, and the apparatus further comprises
means for choosing the frequency and the polarization of the first EM field so as to reduce the absolute value of the light shift of the clock transition frequency;
wherein the light shift curve has a slope at the frequency which corresponds with an energy difference between the at least one of the clock states and the at least one of the first and second excited states, the slope thereat related to the chemical composition and partial pressure of the buffer gas in the cell, and the apparatus further comprises
wherein the chemical composition and partial pressure of the buffer gas reduce the absolute value of the slope of the light shift curve of the clock transition frequency.

2. An apparatus as recited in claim 1, wherein (i) the first EM field is an optical pumping EM field, and (ii) the second EM field is a microwave EM field.

3. An apparatus as recited in claim 1, wherein
the first EM field has a frequency range which includes frequencies corresponding with a plurality of hyperfine states in the atomic particles' first and second excited states which have absolute detuning related to an optical transition linewidth of the at least one of the clock transition states and the at least one of the first and second excited states.

4. An apparatus as recited in claim 3, wherein the frequency of the optical electromagnetic field has a negative detuning for one of the plurality of hyperfine states in the atom's excited state and has a positive detuning for another of the hyperfine states in the atom's excited state.

5. An apparatus as recited in claim 1, wherein the first EM field propagates in the cell along the direction which is at a predetermined, non-zero angle relative to the direction of the bias magnetic field.

6. An apparatus as recited in claim 5, wherein the first EM field propagates in the cell along the direction which is approximately perpendicular to the direction of the bias magnetic field.

7. An apparatus as recited in claim 1 wherein:
the quantum absorber material includes one of an alkaline atom and an alkaline-like ion; and
the transition from the ground state to at least one of the ²P_{1/2} excited states is used for optical pumping to alter the respective populations of the atomic particles at the first and second energy states.

8. An apparatus as recited in claim 7, wherein the quantum absorber material includes one of Li, Na, K, Rb, and Cs.

9. An apparatus as recited in claim 7, wherein the frequency of the optical electromagnetic field is between the transition frequencies from the at least one of the clock transition states to the first and second excited states.

10. An apparatus as recited in claim 9, wherein the frequency of the optical electromagnetic field is approximately the average value of the transition frequencies from the at least one of the ground states to the first and second excited states.

11. An apparatus as recited in claim 9, wherein
the frequency of the optical electromagnetic field includes a frequency between the transition frequencies from the at least one of the ground states to the first and second excited states; and
in the vicinity of the frequency therebetween, the has atomic particles have a local minimum absorption.

12. An apparatus as recited in claim 1, wherein:
for a given frequency, the first EM field is polarized by a combination of at least two of the polarizations (π, σ⁺ and σ⁻); and
the absolute value of the light shift is approximately zero.

13. An apparatus as recited in claim 12, wherein:
the optical electromagnetic field is linearly polarized; and
the angle between the linear polarization and the bias magnetic field is such that the absolute value of the light shift is reduced to approximately zero.

14. An apparatus as recited in claim 1, wherein the buffer gas includes a plurality of components.

15. An apparatus as recited in claim 14, wherein the buffer gas is one of:
a mixture of nitrogen and argon, and
a mixture of methane and argon.

16. A method for producing an output oscillating signal with a stable frequency employing an apparatus including a quantum absorber material that includes atomic particles, the atomic particles having an energy state structure that includes a ground energy state including two clock transition states, and first and second excited states; the two clock transition states and the first and second excited states having respective populations of atomic particles which are at first values at thermal equilibrium, the method comprising:
applying a static bias magnetic field to the atomic particles;
applying a first electromagnetic (EM) field, having a frequency spectrum, to induce transitions, having linewidths, between at least one of the clock transition states and at least one of the first and second excited states, in order to alter the respective populations of the atomic particles in the two clock transition states, so that the resultant population is different from the population at thermal equilibrium without the first EM field;
wherein an output EM field from the cell is related to the first EM field and to the transitions, and has a light shift, relative to the first EM field, the light shift having an absolute value which varies as a function of the frequency of the first EM field;
applying a second EM field to induce transitions between the two clock transition states, so that the absorption of the first EM field by the atomic particles increases, the frequency of the second EM field being related to the frequency of the output oscillating signal;
detecting absorption of the first EM field by the atomic particles;
using the detection of the absorption of the first EM field to control the frequency spectrum of the first EM field;
using the detection of the absorption of the first EM field to control the frequency of the second EM field, so that the frequency of the output oscillating signal is related to the clock transition frequency;
using the energy state structure in the atomic particles' excited states to reduce the absolute value of the light shift of the clock transition frequency, by choosing and controlling the frequency spectrum and the polarization of the first EM field;
wherein the linewidths of the transitions from the clock transition states to the excited states reduce the absolute value of the slope of the light shift of the clock transition frequency at frequencies near the frequency corresponding with the transition energy between the at least one of the clock transition states and the at least one of the first and second excited states.

17. A method as recited in claim 16 wherein:
the first EM field is an optical pumping electromagnetic field; and
the second EM field is a microwave field.

18. A method as recited in claim 16, wherein the quantum absorber material includes one of an alkaline atom and an alkaline-like ion.

19. A method as recited in claim 18, wherein the one of an alkaline atom and an alkaline-like ion are one of the atoms Li, Na, K, Rb, and Cs, and the ions Be⁺, Mg⁺, Ca⁺, Sr⁺, Yb⁺, Ba⁺, Zn⁺, Cd⁺, and Hg⁺.

20. A method as recited in claim 18, wherein the frequency of the first EM field is between the transition frequencies from one of the clock transition states to the at least one of the first and second excited states.

21. A method as recited in claim 18, wherein the frequency of the first EM field is approximately the average value of the transition frequencies from one of the clock transition states to the at least one of the first and second excited states.

22. A method as recited in claim 18, wherein:
the frequency of the first EM field is between the transition frequencies from one of the ground states to the at least one of the first and second excited states; and
in the vicinity of this frequency the quantum absorber material has a local minimum absorption.

23. A method as recited in claim 16, wherein the frequency of the first EM field has:
a negative detuning for at least one hyperfine state (HFS) in the excited state and
a positive detuning for at least one HFS in the excited state.

24. A method as recited in claim 23 wherein the frequency and the polarization of the first EM field reduce the absolute value of the light shift to approximately zero.

25. A method as recited in claim 24, wherein, for a chosen frequency of the first EM field a combination of polarizations (π, σ⁺ and σ⁻) is used to reduce the absolute value of the light shift.

26. A method as recited in claim 25, wherein:
the polarization includes linear polarization; and
an angle between the linear polarization and the static bias magnetic field reduces the absolute value of the light shift to approximately zero.

27. A method as recited in claim 16, further comprising adding a buffer gas to the quantum absorber material, the buffer gas having a pressure such that the slope of the light shift, as a function of first EM field frequency, is reduced to approximately zero.

28. A method as recited in claim 27, wherein the buffer gas includes a plurality of chemical substances.

29. A method as recited in claim 28, wherein the buffer gas includes (i) argon, and (ii) one of nitrogen and methane.
